(19) United States
(12) Patent Application Publication
(10) Pub. No.: US 2022/0015363 A1
(43) Pub. Date: Jan. 20, 2022

(54) SMALL MOLECULE PATHOGEN DISPERSAL AGENT

(71) Applicant: The Trustees of Princeton University, Princeton, NJ (US)

(72) Inventors: Zemer Gitai, Princeton, NJ (US); Robert J. Scheffler, Baltimore, MD (US); Mohamed Abou Donia, Princeton, NJ (US); Yuki Sugimoto, Cambridge, MA (US)

(73) Assignee: The Trustees of Princeton University, Princeton, NJ (US)

(21) Appl. No.: 17/372,952

(22) Filed: Jul. 12, 2021

Related U.S. Application Data
(60) Provisional application No. 63/051,528, filed on Jul. 14, 2020.

(51) Int. Cl. A01N 43/42; A01N 25/04

(52) U.S. Cl. CPC A01N 43/42; A01N 25/04

(57) ABSTRACT

A system and method for dispersing pathogens having Type IV pili that are surface-attached to a surface or preventing pathogens from surface-attaching to a surface, using a certain quinolone compounds (such as 2-methyl-4-hydroxyquinolone (MHQ)) as dispersing agents.

### CROSS-REFERENCE TO RELATED APPLICATIONS

This invention claims priority to 63/051,528, entitled “Small Molecule Pathogen Dispersal Agent, filed on Jul. 14, 2020, which is incorporated by reference in its entirety herein.

### STATEMENT REGARDING FEDERALLY SPONSORED RESEARCH OR DEVELOPMENT

This invention was made with government support under Grant Nos. AI124669 and GM007388 awarded by the National Institutes of Health. The government has certain rights in the invention.

### BACKGROUND

Hospital-acquired infections (HAIs) and the pathogens that cause them are a growing concern due to the rise in antibiotic resistance, which makes treating these infections increasingly difficult. Multi-drug-resistant pathogens are particularly problematic in healthcare settings as hospital patients are often immunocompromised and contaminated surfaces promote bacterial transfer to new patients. The list of contaminated surfaces ranges from medical implants to neckties worn by doctors.

Bacteria often generate a variety of materials that allow them to exist in or on an unexpected number of types of surfaces. For example, Pseudomonas aeruginosa (one of the major causes of a wide variety of HAIs) produces a number of secreted factors including small molecules such as pyocyanin, glycolipids such as rhamnolipids, secreted proteins such as elastase, and nucleic acids, which allow P. aeruginosa to inhabit a wide range of environments and infect a surprising array of hosts.

Certain bacteria upregulate virulence as they progress in stages towards a formed biofilm. The first stage is an initial, reversible attachment to a surface, followed later a second stage, where the bacteria become “irreversibly” attached. In the third stage, a microcolony forms, and in the fourth stage, a multicellular biofilm forms.

To initiate surface-induced virulence, bacteria such as P. aeruginosa sense surfaces through type IV pili (T4P), which are extracellular polymers that can be actively extended and retracted. Thus, disrupting surface attachment or T4P activity could be powerful yet largely untapped methods to combat certain kinds of bacterial pathogenesis, by reducing the propensity to disseminate via surfaces and by reducing the induction of its virulence mechanisms. While previous work has been done to identify compounds that disrupt mature multicellular biofilms, such compounds are not the same as compounds that disrupt early surface attachment.

Thus, compounds that can disrupt surface attachment of bacteria are both useful and desirable.

### BRIEF SUMMARY

The disclosed system and method utilize small molecules, related to molecules P. aeruginosa naturally produces, that can be used to disperse pathogens having Type IV Pili from surfaces.

A first aspect of the present disclosure is a method for dispersing pathogens surface-attached to a surface or preventing pathogens from surface-attaching to a surface. The method for requires providing a dispersing compound comprising a structure according to formula (I) or (II):

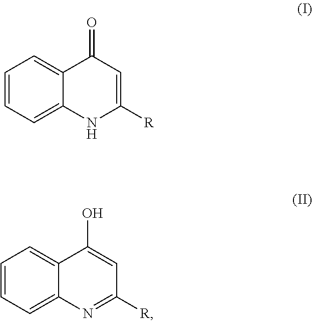

or a derivative thereof, where R is a C1-C8 alkyl, C1-C8 alkenyl, or a C1-C8 alkynyl group. Optionally, the dispersing compound is 2-methyl-4-hydroxyquinoline (MHQ).

The dispersing compound is then applied to a surface that is or could potentially be (or is likely to become) contaminated with a species of bacteria attached to the surface, the bacteria having type IV pili (T4P) (such as a species of Pseudomonas, Myxococcus, Neisseria, Vibrio, or Acinetobacter.

Optionally, the concentration of the dispersing compound applied to the surface is at least 1 mM. Optionally, the dispersing compound is present in an aqueous solution (which may have a pH greater than 7).

Optionally, the dispersing compound is applied to a surface of a pipe or a biomedical surface. Optionally, the surface is already contaminated with the species of bacteria, and the dispersing compound is then allowed to interact with the bacteria and cause the bacteria to disperse. Optionally, the surface is not already contaminated with the species of bacteria.

A second aspect of the present disclosure is a system for dispersing pathogens surface-attached to a surface or preventing pathogens from surface-attaching to a surface. The system comprises (a) a solvent and (b) a dispersing compound comprising a structure according to formula (I) or (II):

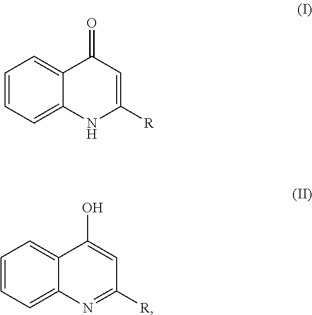

or a derivative thereof, where R is a C1-C8 alkyl, C1-C8 alkenyl, or a C1-C8 alkynyl group. Optionally, the dispersing compound is 2-methyl-4-hydroxyquinoline (MHQ).

Optionally, the system is an aqueous solution, and may have a pH greater than 7. Optionally, concentration of the dispersing compound is at least 1 mM.

### BRIEF DESCRIPTION OF DRAWINGS

FIG. 1 is a graph of the concentration-dependent dispersal activity of a dispersing compound (here, MHQ) on mid-log (OD₆₀₀ 0.6-0.8) P. aeruginosa cells. Mean and standard deviation shown from four biological replicates. Fit is based on a modified Hill equation

$$( y = a * \frac{{x}^{n}}{E {C}_{50}^{n} + {x}^{n}} + b ,$$

y is activity, x is varied condition, a+b=1, EC₅₀ is the effective concentration at which the activity is 50% of the total effect, and the cooperativity coefficient, n, refers to the steepness of the transition between effect and no effect. Here, n was ˜15).

### DETAILED DESCRIPTION

Disclosed is a method and system for dispersing certain pathogens that have initially attached to the surface, or preventing such pathogens from attaching. This is an entirely different treatment approach from the use of antibiotics or bacteriostats, which kill the pathogens or preventing them from reproducing.

The method involves providing a dispersing compound. The dispersing compound comprising a structure according to formula (I) or (II):

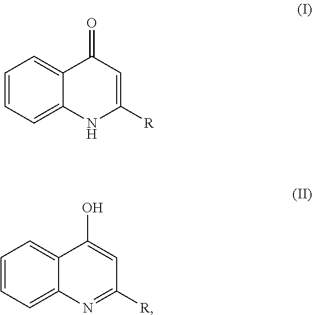

or a derivative thereof, where R is a C₁-C₈ alkyl, C₁-C₈ alkenyl, or a C₁-C₈ alkynyl group. In a preferred embodiment, R is a n-alkyl group.

These dispersing compounds are generally available commercially. For example, commercial standards of MHQ are available through Sigma-Aldrich.

In some embodiments, the dispersing compound is a material that is synthesized by enzymes in one of the pathogen's signaling pathways, and preferably a quinolone signaling pathway. For example, MHQ is synthesized by enzymes in the Pseudomonas quinolone signaling (PQS) pathway.

In a preferred embodiment, the dispersing compound is 2-methyl-4-hydroxyquinoline (MHQ). In another embodiment, the dispersing compound is 2-heptyl-4-hydroxyquinolone (HHQ).

Many of the pathogens, these dispersing compounds inhibit, such as P. aeruginosa, can attach to a surface either by their pole (vertically) or by their side (horizontally). Upon treatment with phosphate buffered saline (PBS), 76% (nₜₒₜₐₗ=1347) of the cells attached to the surface vertically. In contrast, upon treatment with, e.g., 10 mM MHQ, only 5% (nₜₒₜₐₗ=1331) of the cells attached to the surface vertically. A similar behavior is found between MHQ-treated WT cells and mutants lacking Type IV pilin subunits (PilA), as only 7% (nₜₒₜₐₗ=1995) of ΔpilA cells were attached vertically even in PBS treatment. This result suggested that the dispersing agent disrupts T4P activity.

Since T4P is required for twitching motility, the dispersing compound's effect on a pathogen can be seen in a twitching assay. In this assay, cells are placed underneath agar and allowed to spread from their starting spot along the bottom surface of a Petri dish. The extent of this spread is visualized with crystal violet staining and quantified. In the presence of agar made with LB, WT cells traveled 11±0.7 mm (mean±SD) from the starting spot. In contrast, in the presence of agar made with LB and 2 mM MHQ, WT cells traveled significantly less (7±0.5 mm). The effect of MHQ on twitching depended on T4P, as ΔpilA cells that lack T4P traveled similar distances away from the starting spot in the absence of MHQ (1.9±0.1 mm) or in the presence of MHQ (2.3±0.3 mm).

To directly assay the effect of a dispersing compound on T4P activity, the recently developed cysteine-labeling approach can be used to fluorescently label T4P and image their dynamics. This approach uses a cysteine point mutation in an unstructured loop of the PilA pilin subunit to label the pili through maleimide-based click chemistry. In one experiment, the pili of untreated cells were labeled and then imaged T4P dynamics after a brief (5 min) exposure to MHQ or PBS control. Following a 5 min mock treatment with PBS, T4P were seen extending and retracting from 77% of the cells (n=473). In contrast, when cells were treated with 2 mM MHQ for 5 min, only 4% (n=493) of the cells exhibited any T4P extension or retraction events. Since the T4P was labeled before MHQ treatment and the treatment was brief, this effect cannot be attributed to effects of MHQ on TFP expression or labeling. Similar results can be seen with other disclosed dispersing compounds. Thus, it is clear that the dispersing compounds inhibits TFP activity.

In some embodiments, the dispersing compound is the only material used to disperse the pathogens. Preferably, however, the dispersing compound is part of a system.

Specifically, in some embodiments, the system includes a composition comprising (i) the dispersing compound and (ii) a solvent. In some embodiments, the solvent comprises water (and thus, the composition is an aqueous solution). In other embodiments, the solvent comprises water and an alcohol (such as ethanol). In some embodiments, the composition is an emulsion, comprising water and surfactants in addition to the dispersing compound.

In preferred embodiments, the pH of the system/composition is greater than 7. In more preferred embodiments, the pH of the system/composition is greater than 8. In some embodiments, the pH of the system/composition is between 8 and 10, including between 8 and 9.

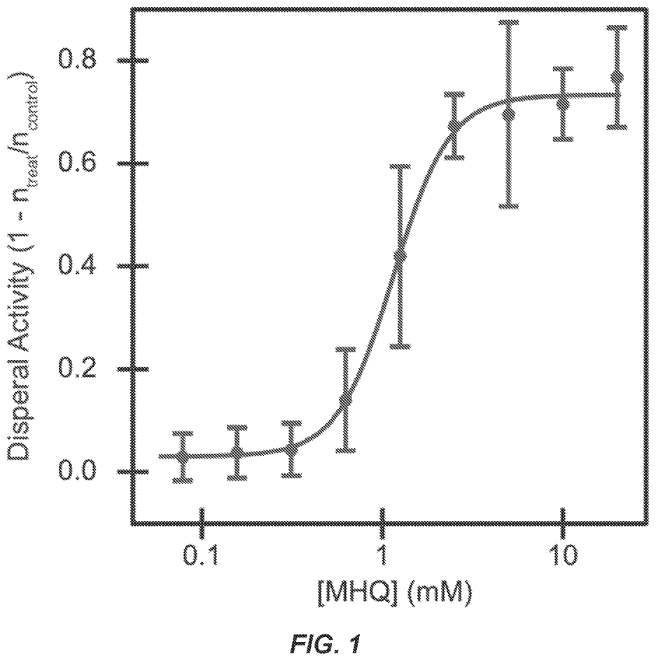

A dilution series of the dispersing compound can reveal the compound's effective concentration (EC₅₀) for dispersal activity. See, e.g., FIG. 1, which shows the dispersal activity of MHQ. Other disclosed dispersing agents provide similar curves.

In preferred embodiments, the concentration of the dispersing compound in the system/composition is at least 1 mM. In more preferred embodiments, the concentration of the dispersing compound is ≥2 mM, ≥5 mM, ≥10 mM, or ≥20 mM. In some embodiments, the concentration is <100 mM, <80 mM, or <50 mM.

The disclosed method then involves applying the dispersing compound to a surface that is or could potentially be contaminated with a species of bacteria attached to the surface, where the bacteria have type IV pili (T4P).

This method can be applied to any bacteria having T4P. As is known in the art, T4P are among the most widespread cell surface appendages in bacteria and have been found in beta-, gamma-, delta-, and epsilon-proteobacteria and cyanobacteria, as well as in firmicutes. In preferred embodiments, the bacteria having T4P is a species of Pseudomonas, Myxococcus, Neisseria, Vibrio, Synechocystis, or Acinetobacter.

For example, in some embodiments, the Pseudomonas sp, may be from the P. aeruginosa group (e.g., P. aeruginosa, P. alcaligenes, P. anguilliseptica, P. argentinensis, P. borborid, P. citronellolis, P. flavescens, P. mendocina, P. nitroreducens, P. oleovorans, P. pseudoalcaligenes, P. resinovorans, P. straminea), the P. chlororaphis group (e.g., P. aurantiaca, P. aureofaciens, P. chlororaphis, P. fragi, P. lundensis, P. taetrolens), the P. fluorescens group (e.g., P. antarctica, P. azotoformans, P. blatchfordae, P. brassicacearum, P. brenneri, P. cedrina, P. corrugata, P. fluorescens, P. gessardii, P. libanensis, P. mandelii, P. marginalis, P. mediterranea, P. meridiana, P. migulae, P. mucidolens, P. orientalis, P. panacis, P. proteolytica, P. rhodesiae, P. synxantha, P. thivervalensis, P. tolaasii, P. veronii), the P. pertucinogena group (e.g., P. denitrificans, P. pertucinogena), the P. putida group (e.g., P. cremoricolorata, P. entomophila, P. fulva, P. monteilii, P. mosselii, P. oryzihabitans, P. parafulva, P. plecoglossicida, P. putida), the P. stutzeri group (e.g., P. balearica, P. luteola, P. stutzeri), the P. syringae group (e.g., P. amygdali, P. avellanae, P. caricapapayae, P. cichorii, P. coronafaciens, P. ficuserectae, P. helianthi, P. meliae, P. savastanoi, P. syringae, P. tomato, P. viridiflava), or others, including, e.g., P. abietaniphila, P. acidophila, P. agarici, P. alcaliphila, P. alkanolytica, P. amyloderamosa, P. asplenii, P. azotifigens, P. cannabina, P. coenobios, P. congelans, P. costantinii, P. cruciviae, P. delhiensis, P. excibis, P. extremorientalis, P. frederiksbergensis, P. fuscovaginae, P. gelidicola, P. grimontii, P. indica, P. jessenii, P. jinjuensis, P. kilonensis, P. knackmussii, P. koreensis, P. lini, P. lutea, P. moraviensis, P. otitidis, P. pachastrellae, P. palleroniana, P. papaveris, P. peli, P. perolens, P. poae, P. pohangensis, P. protegens, P. psychrophila, P. psychrotolerans, P. rathonis, P. reptilivora, P. resiniphila, P. rhizosphaerae, P. rubescens, P. salomonii, P. segitis, P. septica, P. simiae, P. suis, P. teessidea, P. thermotolerans, P. toyotomiensis, P. tremae, P. trivialis, P. turbinellae, P. tuticorinensis, P. umsongensis, P. vancouverensis, P. vranovensis, P. xanthomarina, or a combination thereof.

For example, in some embodiments, the Myxococcus sp. may be from M. flavesscens, M. fulvus, M. macrosporus, M. stipitatus, M. vireseens, M. xanthus, M. coralloides, M. disciformis, M. hansupus, M. eversor, vastator, or a combination thereof.

For example, in some embodiments, the Neisseria sp. may be from N. animalis, N. animaloris, N. bacilliformis, N. canis, N. cinerea, N. dentiae. N. elongate, N. flava, N. flavescens, N. gonorrhoeae, N. iguanae, N. lactamica, N. macacae, N. meningitidis, N. mucosa, N. oralis, N. perflava, N. pharyngis, N. polysaccharea, N. shayeganii, N. sicca, N. subflava, N. wadsworthii, N. weaver, or N. zoodegmatis, or a combination thereof.

For example, in some embodiments, the Vibrio sp. may be from V. adaptatus, V. aerogenes, V. aestivus, V. aestuarianus, V. agarivorans, V. albensis, V. alfacsensis, V. alginolyticus, V. anguillarum, V. areninigrae, V. artabrorum, V. atlanticus, V. atypicus, V. azureus, V. brasiliensis, V. bubulus, V. calviensis, V. campbellii, V. casei, V. chagasii, V. cholerae, V. cincinnatiensis, V. coralliilyticus, V. crassostreae, V. cyclitrophicus, V. diabolicus, V. diazotrophicus, V. ezurae, V. fluvialis, V. fortis, V. furnissii, V. gallicus, V. gazogenes, V. gigantis, V. halioticoli, V. harveyi, V. hepatarius, V. hippocampi, V. hispanicus, V. ichthyoenteri, V. indicus, V. kanaloae, V. lentus, V. litoralis, V. logei, V. mediterranei, V. metschnikovii, V. mimicus, V. mytili, V. natriegens, V. navarrensis, V. neonatus, V. neptunius, V. nereis, V. nigripulchritudo, V. ordalii, V. orientalis, V. pacinii, V. parahaemolyticus, V. pectenicida, V. penaeicida, V. pomeroyi, V. ponticus, V. proteolyticus, V. rotiferianus, V. ruber, V. rumoiensis, V. salmonicida, V. scophthalmi, V. splendidus, V. superstes, V. tapetis, V. tasmaniensis, V. tubiashii, V. vulnificus, V. wodanis, V. xuii, or a combination thereof.

For example, in some embodiments, the Synechocystis sp. may be from, e.g., S. aqualtills, or Synechocystis sp. PCC 6803.

For example, in some embodiments, the Acinetobacter sp. may be from A. albensis, A. apis, A. baumannii, A. baylyi, A. beijerinckii, A. bereziniae, A. bohemicus, A. boissieri, A. bouvetii, A. brisouii, A. calcoaceticus, A. celticus, A. chengduensis, A. colistiniresistens, A. courvalinii, A. cumulans, A. defluvii, A. dispersus, A. dijkshoorniae, A. equi, A. gandensis, A. gerneri, A. guangdongensis, A. guerrae, A. guillouiae, A. gyllenbergii, A. haemolyticus, A. harbinensis, A. indicus, A. junii, A. kookii, A. lactucae, A. lanii, A. larvae, A. lwoffii, A. modestus, A. nectaris, A. nosocomialis, A. oryzae, A. parvus, A. pakistanensis, A. populi, A. portensis, A. proteolyticus, A. pittii, A. piscicola, A. pragensis, A. proteolyticus, A. pseudolwoffii, A. pullicarnis, A. pullorum, A. puyangensis, A. qingfengensis, A. radioresistens, A. rudis, A. schindleri, A. seifertii, A. shaoyimingii, A. soli, A. stercoris, A. tandoii, A. tjernbergiae, A. towneri, A. ursingii, A. variabilis, A. venetianus, A. vivianii, A. wanghuae, A. wuhouensis, or a combination thereof.

There are no practical limits on the type of surface that the dispersing compound can be applied to. In some embodiments, such surfaces can include, e.g., the internal or external surfaces of pipes, tubes, or other components that transport fluids. In some embodiments, such surfaces may be a biomedical surfaces, such as a surface of a suture, implant (including, vascular prostheses, hernia meshes, etc.) and scaffolds, that, e.g., have risks for surgical site infections.

In some embodiments of the method, the surface is already contaminated with one or more species of bacteria having T4P. In such cases, the method may optionally also include allowing the dispersing compound to interact with the bacteria and cause the bacteria to disperse.

The amount of time varies based on, e.g., the efficacy and concentration of the dispersing compound. In some embodiments, for example, low concentrations (1 μM or less) of MHQ as the dispersing compound, the MHQ may need to remain in contact with the surface for up to 10 minutes to completely disperse a pathogen.

In some embodiments, however, the surface is not already contaminated with the species of bacteria. In such cases, the dispersing compound may be allowed to remain on the surface, to prevent any bacteria having T4P from attaching to the surface.

What is claimed is:

1. A method for dispersing pathogens surface-attached to a surface or preventing pathogens from surface-attaching to a surface, comprising:
providing a dispersing compound comprising a structure according to formula (I) or (II): 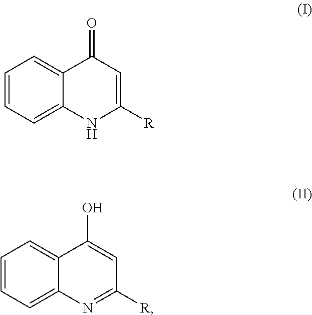
or a derivative thereof, where R is a C₁-C₈ alkyl, C₁-C₈ alkenyl, or a C₁-C₈ alkynyl group; and
applying the dispersing compound to a surface that is or could potentially be contaminated with a species of bacteria attached to the surface, the bacteria having type IV pili (T4P).

2. The method according to claim 1, wherein the bacteria having T4P is a species of Pseudomonas, Myxococcus, Neisseria, Vibrio, or Acinetobacter.

3. The method according to claim 1, wherein the dispersing compound is 2-methyl-4-hydroxyquinoline (MHQ).

4. The method according to claim 1, wherein the concentration of the dispersing compound applied to the surface is at least 1 mM.

5. The method according to claim 1, wherein the dispersing compound is present in an aqueous solution.

6. The method according to claim 4, wherein the aqueous solution has a pH greater than 7.

7. The method according to claim 1, wherein the surface is a pipe.

8. The method according to claim 1, wherein the surface is a biomedical surface.

9. The method according to claim 1, wherein the surface is already contaminated with the species of bacteria.

10. The method according to claim 8, further comprising allowing the dispersing compound to interact with the bacteria and cause the bacteria to disperse.

11. The method according to claim 1, wherein the surface is not already contaminated with the species of bacteria.

12. A system for dispersing pathogens surface-attached to a surface or preventing pathogens from surface-attaching to a surface, comprising:
a dispersing compound comprising a structure according to formula (I) or (II): 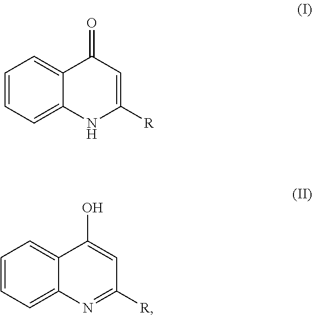
or a derivative thereof, where R is a C₁-C₈ alkyl, C₁-C₈ alkenyl, or a C₁-C₈ alkynyl group; and
a solvent.

13. The system according to claim 12, wherein the dispersing compound is 2-methyl-4-hydroxyquinoline (MHQ).

14. The system according to claim 12, wherein the system is an aqueous solution.

15. The system according to claim 12, wherein the pH of the system is greater than 7.

16. The system according to claim 12, wherein the concentration of the dispersing compound is at least 1 mM.
